(19) United States
(12) Patent Application Publication
(10) Pub. No.: US 2011/0238379 A1
(43) Pub. Date: Sep. 29, 2011

(54) ENABLING CAPTURE, TRANSMISSION AND RECONSTRUCTION OF RELATIVE CAUSITIVE CONTEXTURAL HISTORY FOR RESOURCE-CONSTRAINED STREAM COMPUTING APPLICATIONS

(75) Inventors: Archan Misra, Bridgewater, NJ (US); Benjamin Falchuk, Upper Nyack, NY (US); Atanu Roy Chowdhury, Kolkata (IN)

(73) Assignee: TELCORDIA TECHNOLOGIES, INC., Piscataway, NJ (US)

(21) Appl. No.: 12/893,402

(22) Filed: Sep. 29, 2010

Related U.S. Application Data
(60) Provisional application No. 61/246,589, filed on Sep. 29, 2009.

(51) Int. Cl. G06F 17/40

(52) U.S. Cl. 702/187

(57) ABSTRACT

A scalable middleware for supporting energy-efficient, long-term remote health monitoring and the capture and transmission of relative causative contextual history where data is collected using physiological sensors and transported back to the middleware through a mobile device serving as a gateway. The key to energy efficient operations lies in the adoption of an Activity Triggered Deep Monitoring paradigm, where data collection episodes are triggered only when the system is determined to possess a specified set of causative contexts. The system supports on-demand collection of causative contextual history using a low-overhead provenance collection sub-system. In a preferred embodiment the behavior of this sub-system is configured using an application-defined context composition graph. The resulting causative context history stream provides valuable insight into the states and conditions surround sensor readings and allows improved human interpretation of the ‘episodic’ sensor data streams.

### CROSS-REFERENCE TO RELATED APPLICATIONS

This application claims the benefit of U.S. Provisional Application No. 61/246,589, filed on Sep. 29, 2009, which is incorporated by reference herein in its entirety.

### FIELD OF THE INVENTION

The present invention relates to specifying, capturing, collecting, storing, transferring and replaying over metadata causative contextual history that elaborates on data collected by an adaptive remote monitoring application using a mobile device. Specifically, the invention has application to remote health monitoring of individuals using a mobile device such as a smart phone.

### BACKGROUND OF THE INVENTION

Remote health monitoring services promise significant improvements in healthcare delivery and chronic disease management by providing new and detailed insights about the evolution of disease symptoms or biomedical markers. Such remote monitoring and automated medical analytics are becoming increasingly plausible, thanks to recent developments in miniaturized physiological sensors, effective low-power personal area network (PAN) radios, powerful handheld computing devices and almost-ubiquitous wireless connectivity. A logical three-tier architecture such as that described in D. Husemann, C. Narayanaswami, and M. Nidd. Personal mobile hub. In ISWC 04: Proceedings of the Eighth International Symposium on Wearable Computers (ISWC04), 2004 comprises a server for backend integration, a cellular phone/handheld device based personal gateway and a body-worn set of sensors seems most suited to support such a remote health monitoring service.

The act of monitoring, processing and transporting the medical sensor streams is associated with a non-trivial energy cost, that manifests itself as a resource bottleneck when employing battery powered devices. In untethered deployments, there is thus a clear tradeoff between the system lifetime and the rate of data generation. For example, C. Kirsch, M. Mattingley-Scott, C. Muszynski, F. Schaefer, and C. Weiss. Monitoring chronically ill patients using mobile technologies. IBM Systems Journal, 46(1):8593, 2007 supports longer deployment periods for low data rate sensors, whereas R. Jafari, F. Dabiri, P. Brisk, and M. Sarrafzadeh. Adaptive and fault tolerant medical vest for life-critical medical monitoring. In SAC 05: Proceedings of the 2005 ACM symposium on Applied computing, pages 272279, 2005 and T. Gao, et al, The Advanced Health and Disaster Aid Network: A Light-weight Wireless Medical System for Triage, IEEE Transactions on Biomedical Circuits and Systems, Volume 1, Issue 3, September 2007 support higher data rates for shorter durations. To address this tradeoff, we have previously introduced the Activity Triggered Deep Monitoring (ATDM) paradigm in A. Misra, B. Falchuk and S. Loeb, Server-assisted Context-Dependent Pervasive Wellness Monitoring, in WIPH'09: 2009 International Workshop on Wireless Pervasive Healthcare, March 2009, which is incorporated herein by reference, whereby fidelity sensor data streams are collected and transported only when deemed necessary in light of information contained on a networked server. By employing a context-triggered monitoring approach, ATDM produces streams of health sensor data that are episodic and have varying granularity and duration.

The present invention describes MediAlly, a remote health monitoring service that conforms to the ATDM paradigm and supports a low overhead sub-system for collecting, storing and replaying the contextual provenance associated with the monitored sensor data streams. Here, provenance refers to the ability of MediAlly to collect, store and (at a future time) reconstruct the evolution of the subject's contextual states that acted as ATDM triggers. It is observed that such reconstructed context provides invaluable insight into the episodic data streams themselves, as well as aids in reasoning, for example, about the lack of data collection between the episodes of high-fidelity monitoring, or about the reasons for changing into high-fidelity monitoring. For example, a doctor would find it useful to know if a data stream corresponding to “30 minutes of elevated heart rate”, recorded a month ago, occurred while the subject was exercising at a healthclub or was at home. As another example, the doctor would find it useful to know that a data stream was not collected because the sensors were reporting a low battery state. For practical considerations, the MediAlly service architecture is designed to incorporate third party personal health repositories (PHR) like Google Health™ or Microsoft HealthVault™, by a) logically separating the ‘health’ data streams from the ‘context’ metadata stream, and b) providing programmatic APIs to combine these streams as and when necessary.

The present invention overcomes the limitations of the prior art by using a cellphone or PDA as a gateway for collecting health data from a variety of medical sensors. While initial prototypes focused on using the cellphone merely as a relay for very infrequently collected medical data (e.g., daily glucose readings as described in C. Kirsch, M. Mattingley-Scott, C. Muszynski, F. Schaefer, and C. Weiss. Monitoring chronically ill patients using mobile technologies. IBM Systems Journal, 46(1):8593, 2007) prototypes have explored the use of localized processing on the mobile device to enable continuous monitoring of health sensor data streams. These include the AMON system disclosed in P. Lukowicz, et al, AMON: A Wearable Medical Computer for High Risk Patients, pp. 0133, Sixth International Symposium on Wearable Computers (ISWC'02), 2002 for multi-parameter (Sp02, pulse and temperature) monitoring, the MoteCare system described in E. Lubrin, E. Lawrence, and K. F. Navarro. Motecare: An Adaptive Smart BAN Health Monitoring System. In BioMed06: Proceedings of the 24^{th} TASTED international conference on Biomedical engineering, February 2006, personalized health monitoring, and the COSMOS middleware described in Y. B. Kim, M. Kim and Y. Lee, COSMOS: a middleware platform for sensor networks and a u-healthcare service, SAC 2008: 512-513 for ubiquitous monitoring using ZigBee-based sensors. More recently, the Harrnoni prototype described in I. Mohomed, A. Misra, M. Ebling, W. Jerome: HARMONI: Context-aware Filtering of Sensor Data for Continuous Remote Health Monitoring. PerCom 2008 used activity context as a trigger for dynamically altering the stream-processing logic on the cellphone, with a view to reducing the transmission overheads of medically unimportant data. The Micro-blog middleware in S. Gaonkar, J. Li, R. Roy Choudhury, L. Cox and A. Schmidt, Micro-Blog: Sharing and Querying Content Through Mobile Phones and Social Participation, MobiSys '08: Proceeding of the 6th international conference on Mobile systems, applications, and services, June 2008, was one of the first to comprehensively demonstrate how the on-board sensors of a collection of commodity mobile phones (e.g., camera, GPS accelerometers) could be used to develop useful insight into real-world context state. Based on the observation that all of these prototypes have limited operational lifetime between recharges (as they all assume continuously arriving streams of medical data), the ATDM paradigm was proposed, where activity context is suggested as a trigger for altering when, how, and what health data is collected.

In all of this prior work, there has been no notion of tracking and storing the individual's personal and global context with the aim of providing explanatory provenance on the underlying historical health data. The problem is challenging and no obvious solutions exist.

The idea of using a combination of locally-generated and cloud context to provide a better situational awareness of an individual's activity has been explored recently, largely due to the increasing availability of near-real time information on the Web (“cloud” data refers to managed distributed data stored in repositories accessible over Internet using application interfaces). For example, B. Falchuk, S. Loeb, T. Panagos, “A Deep-Context Personal Navigation System”, Proc. ITS America 15th World Congress on Intelligent Transportation Systems, 2008 explored the use of an individual's calendar context and roadway traffic context in building an enhanced, personalized navigation system. The use of cloud-based sentiment context is based on a variety of machine learning and classification based techniques that have been recently explored for automatic inference of sentiment, including the classification of product reviews described in K. Dave, S. Lawrence, and D. M. Pennock. Mining the peanut gallery: opinion extraction and semantic classification of product reviews. InWWW '03:Proceedings of the 12th international conference on World Wide Web, pages 519528. ACM, 2003 and the detection of an individual's mood changes through blog analysis as described in R. McArthur, Uncovering deep user context from blogs, Proceedings of the second workshop on Analytics for noisy unstructured text data (AND), 2008.

Broadly speaking, prior work can be categorized into two parts:

Provenance support for general e-science such as descried in Simmhan, Y. L., Plale, B. and Gannon, D. Performance Evaluation of the Karma Provenance Framework for Scientific Workflows. International Provenance and Annotation Workshop (IPAW), May 2006, Groth, P., Luck, M., and Moreau, L. A protocol for recording provenance in service-oriented grids. In Proceedings of the 8^{th} International Conference on Principles of Distributed Systems (OPODIS'04), December 2004, and Chen, L., et al. A proof of concept: Provenance in a Service Oriented Architecture. In Proceedings of the Fourth All Hands Meeting (AHM), September 2005 and file system as disclosed in Muniswamy-Reddy, K., Holland, D., Braun U., and Seltzer, M. Provenance-Aware Storage Systems. In Proceedings of the 2006 USENIX Annual Technical Conference, June 2006 applications. These approaches do not consider how context may be used to change various aspects of data monitoring.

Data monitoring via mobile devices. These approaches simply send all monitored information as data streams such as in Husemann, D., Narayanaswami, C., and Nidd, M. Personal Mobile Hub. 8th International Symposium on Wearable Computers (ISWC 2004), November 2004. Lubrin, E., Lawrence, E., and Navarro, K. F. MoteCare: An Adaptive Smart BAN Health Monitoring System. In Proceedings of the 24th LASTED international conference on Biomedical Engineering, February 2006-they do not provide ways for applications to make a distinction between the collected data and the associated metadata, and do not present any ways to collect, transfer and index the metadata.

Approaches that require the monitoring application to treat the context metadata as simply other data streams do not support the provenance navigation capabilities provided by the present invention and also would require the application-specific data repositories to be upgraded to accommodate the additional forms of contextual metadata. In current practices, the sensor data collected is stored in appropriate repositories. In the exemplary use case involving remote health monitoring, the data corresponds to various medical sensors (e.g., ECG, EMG, HR etc.) and the repository could be a personal health record (MR) system, such as Microsoft HealthVaule™ or Google Health. Such repositories are concerned with only storing the data, but not the metadata associated with the logic of the monitoring process. For many applications (e.g., electronic health monitoring), the metadata is however often very useful for providing added explanation of the data artefacts and enhancing the utility of the monitored data—e.g., a doctor who observes a data chart indicating high heart rate (HR) readings would benefit from the associated contextual metadata that the user was likely to ‘have been running for more than 15 minutes at that time’. Accordingly, we refer to the associated ‘context’ metadata of the user as provenance, as it helps consumers of the monitored data to gain a deeper understanding of why and under what conditions the data was collected.

The present invention of a causative contextual history system architecture follows in an unobvious way from several recent advances in the field of process and data provenance, investigated primarily for scientific worklows in Y. Simmhan, B. Plale and D. Gannon, Performance Evaluation of the Karma Provenance Framework for Scientific Workflows. International Provenance and Annotation Workshop (IPAW), May 2006, file systems in K. Muniswamy-Reddy, D. Holland, U. Braun and M. Seltzer, Provenance-Aware Storage Systems. In Proceedings of the 2006 USENIX Annual Technical Conference, June 2006 and databases in J. Widom. Trio: A System for Integrated Management of Data, Accuracy, and Lineage. Proc. Second Biennial Conference on Innovative Data Systems Research (CIDR '05), January 2005. The present invention of representing the logic of context composition as a graph is similar in a sense to N. Vijayakumar and B. Plale, Towards Low Overhead Provenance Tracking in Near Real-Time Stream Filtering. International Provenance and Annotation Workshop (IPAW), May 2006, which uses a graph-like representation to support low-overhead process provenance tracking in streambased applications. The present invention, however, has two key differences with Vilayakumar et al. First, while Vilayakumar et al focuses on merely capturing the edge linkages between the graph nodes (representing stream operators), we are interested in additionally efficiently capturing the evolution of each individual node (context state). Moreover, we explicitly consider a combined push-and-pull method of context computation and thus dynamically modify the provenance capture to track the states of only those nodes which actually affect the context computation at any instant. The present invention of causative contextual history representation and reconstruction also utilizes the low-overhead model-based TVC approach to stream provenance introduced in M. Blount, J. Davis, A. Misra, D. M. Sow and M. Wang, A time and value centric provenance model and architecture for medical event streams, in HealthNet, 2007. In this approach, the dependencies between the output and input elements of any stream operator are specified in terms of a functional model, enabling easy reconstruction of incoming data elements (in contrast the present invention uses finer-grained context) that contributed to the generation of an output data element (in contrast the invention uses higher-level composed context).

In summary, continuous remote health monitoring of individuals via the use of a mobile device such as a smart phone-based monitoring applications remains a technological challenge—due to the high data rates and communication overheads, the smart phone or mobile device runs out of battery energy unacceptably quickly (e.g., in 4-7 hours depending on several factors). To extend the lifetime of the monitoring applications, the invention relies upon the idea of using context, both local and global, about the user on the mobile device to influence the process and parameters of data collection e.g., collect data from the sensors only when the patient is engaged in vigorous physical activity. As a result, the data collected and stored in data repositories is episodic and has time-variable attributes. This same episodic nature, while good for efficiency, may confuse practitioners who are reading the data. In other words, data consumers (e.g., physicians) would benefit from understanding the context used in the collection problem. Since the schemas and characteristics of the medical data differs very much from the context metadata, a solution is needed to the problem of how the context metadata can be stored and also associated with the data. Key challenges are how to express such metadata and its connection to different data collection actions, efficiently capture and transmit such metadata and associate such metadata with the collected data.

### SUMMARY OF THE INVENTION

In a preferred embodiment of the invention, a mobile device is used as a data cache for data collected from a set of biomedical sensors that are either on-board the mobile device or connected to it over a personal area network (PAN); it is also used as a communications gateway, formatting and relaying data over a wireless network. For energy efficiency and other reasons, various parameters of the data collection process (such as the time periods when the data is collected, from which sensors the data is collected and how the data is processed on the mobile device) are modified based on various aspects of the device user's context (which itself may be derived from a collection of local sensor and global data sources), such as whether the user is running or walking, where the user is located and the emotional context (e.g., optimistic, negative) of the user (to the extent that this can be computed or derived from various sensor data and other sources).

Our analysis reveals that continuous transmission of high data rate medical data streams can often impose impractical traffic loads on existing wireless PAN technologies likely to be used between the sensors and the mobile gateway. Accordingly, we proposed the Activity Triggered Deep Monitoring (ATDM) paradigm as an energy saving tradeoff, where the sensor devices are activated and data streams collected and relayed by the mobile gateway only when the monitored individual's context is determined to satisfy certain predicates. Determining and capturing context in a canonical machine-readable form requires the use of sensor-generated inputs and will itself be subject to some degree of estimation uncertainty. We assert that the user context can be sufficiently determined by using a combination of both on-board sensors (located on the mobile device) and remote data sources with significantly lower power consumption.

Thus, under the ATDM paradigm, the mobile gateway takes on the additional role of a personal activity coordinator that uses information available from its internal sensors to infer the subject's context. For example, on-board GPS sensors can provide location information, a microphone can provide ambient noise levels and the onboard accelerometer can be used as the basis for a pedometer. The mobile device also has access to personal information, e.g. the subject's calendar. More importantly, there is an increasing amount of generic and personalized context that is stored in the network cloud (e.g., Internet). For example, www.weather.com can be used to obtain environmental parameters (such as temperature and air quality measurements) in the subject's current location. Individuals also express and share their activities (both physical and mental) on many channels—examples include blogging (Google Blogger™), microblogging (Twitter™), and social networking (Facebook, Google Orkut™). Appropriate extraction of this kind of data and subsequent reasoning over it can provide deeper causative context about a subject. This combination of local and cloud sources can provide context of sufficient accuracy to control the duty cycle of the external physiological sensors and, more generally, alter the data processing logic.

The invention involves the use of a separate metadata monitoring subsystem on the mobile device that collects the temporal evolution of the metadata and stores it separately from the actual data collected. Embodiments of the invention allow for both efficient a) specification of the relationship among such metadata and b) transmission of the metadata to a backend provenance store, separate from the actual transmission of the data to a data repository. Separating the metadata collection mechanism from the actual transfer of the monitored data has three benefits: a) it allows such metadata to be overlaid or associated with the monitored data even if the monitored data is stored in legacy data repositories that do not support such metadata storage, b) it allows a cleaner enforcement of ‘separation of concerns’ between the data collection logic and the process of monitoring context and thus fewer bugs and logic errors originating from developers, and c) it allows multiple monitoring applications, potentially concurrently active on the mobile device, to avoid redundant collection by exploiting a common provenance subsystem. The invention also provides a means by which the monitored data can be matched or paired up with the corresponding metadata, at different levels of resolution, even though the two have been stored and managed by different storage infrastructures.

The need for capturing and reconstructing the contextual state associated with a remote monitoring application originated from our observations that more obvious remote monitoring solutions (e.g., one where the data from all sensors is continuously collected all the time) are not practical due to energy limitations on the mobile device. As a consequence, we discovered the idea of having contextual state as a predicate to alter various aspects of the remote monitoring and data collection process (e.g., the time intervals when the data is collected or the sensors from which the data is collected). The mechanisms for obtaining and transmitting such contextual state from a mobile device, in a low-overhead fashion, are not yet clearly understood in the community—hence, the inventors have discovered a particular approach which is both non-obvious and brings new practical benefits to the field.

Preliminary analysis of synthetic monitoring traces suggests that context-modulated remote monitoring could improve the energy efficiency of health monitoring by as much as 70%. Enabling the collection and storage of causative contextual history is likely to improve the diagnostic accuracy of remote medical analysis by a significant amount.

A novel aspect of the invention is the explicit separation between the data collected in remote monitoring and the contextual predicates or provenance metadata that affects the remote monitoring logic.

A further aspect of the invention is the definition of a structure (the specification of an operator graph-based representation of the context composition process) and the use of the structure to recreate provenance at different levels of granularity, while maintaining low-overhead transmission of provenance from the mobile device.

Another aspect of the invention is the defining and use of a separate provenance collection and transmission middleware, separate from the remote monitoring application, with both mobile device (client-side) and backend (server-side) components, that is responsible for efficiently transmitting and replaying the causative contextual history metadata.

The present invention provides a method to collect and store context metadata so that it can provide consumers of the monitored data more insight into the conditions under which the data was generated.

The present invention also provides a way to efficiently track the evolution of individual context states and recreate the relevant contextual history, at appropriate depth, when queried.

There is a novel functional architecture for explicit collection of the contextual metadata that supplies the necessary provenance to the captured health data.

There is also a programming model for provenance enabled remote healthcare monitoring, where developers have control over the granularity of the contextual metadata.

There is also a new graph-based model for efficiently representing, capturing and reconstructing the time-varying contextual metadata, at different levels of granularity and at different levels of “context composition”. The model employs a novel lazy capture principle to significantly reduce overheads, while preserving the accuracy of provenance reconstruction.

The present invention will be more clearly understood when the following description is read in conjunction with the accompanying figures.

### BRIEF DESCRIPTION OF THE DRAWINGS

FIG. 1 is a block diagram of the principal components of a system for capturing causative contextual history for remote monitoring.

FIG. 2 is a table showing an exemplary embodiment of the adaptation logic employed by the monitoring application, and its dependence on the user's contextual state.

FIG. 3 is a tree-like graph of hierarchical context composition of the operator graph for Rule 2 in FIG. 2.

FIG. 4 is a flowchart of logical steps for practicing the present invention.

FIG. 5 is a block diagram of the component-level functional architecture of the present invention.

FIG. 6 shows the flow logic of the present invention.

### DETAILED DESCRIPTION

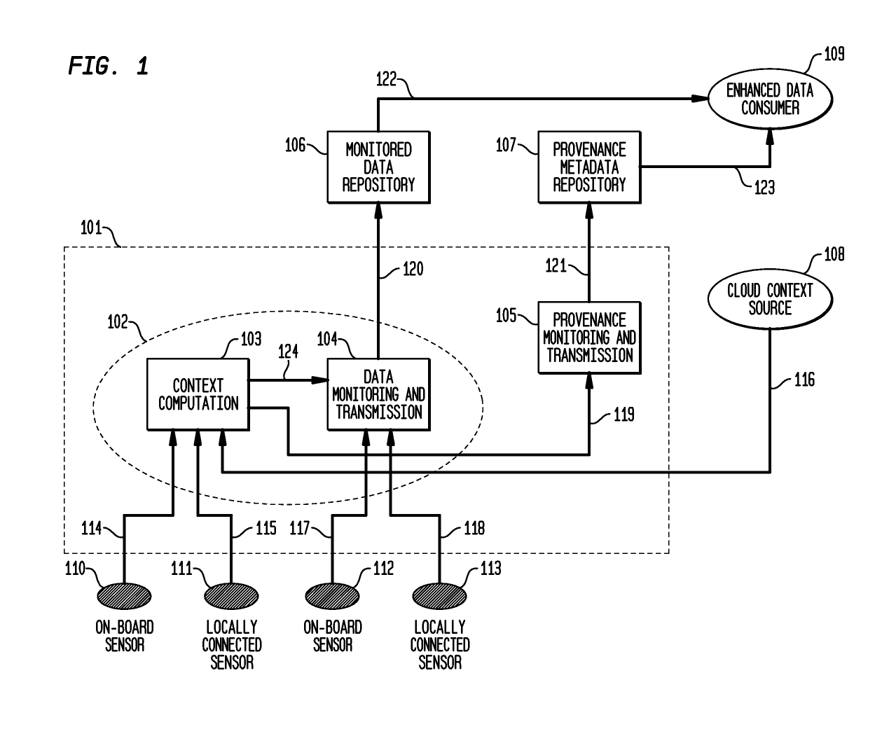

Referring now to the figures and to FIG. 1 in particular, there is shown a block diagram of the principal components of a system 100 for capturing causative contextual history for remote monitoring. An adaptive remote monitoring application 102 is an application residing on a mobile device 101 and its logic is modeled as a combination of a context computation component 103 and a data monitoring and transmission component 104. The context computation component computes the context, using data from a set of on-board sensors (e.g., GPS) 110, a locally collected sensor (e.g., ECG) 111 and data retrieved from a remote data source located in a computing cloud source 108, which feed their data 114, 115 and 116 respectively to the context computation component 103. The data monitoring and transmission component in turn has processing logic that is modified 124 by the context computation component, and in turn uses received data 117, 118 from both on-board sensors 112 and locally connected sensors 113, and finally communicates 120 appropriate raw or transformed data to a monitored data repository 120. The changes in the computed context are tracked 119, using either push or pull techniques, by a provenance monitoring and transmission component 105, which will then communicate 121 the history of such context evolution (with or without further processing) to a backend provenance metadata repository 107. By appropriately indexing the stored data, the backend metadata repository is able to maintain a history of the user's relevant contextual states. By instrumenting the application, either manually or automatically, to report to the provenance monitoring and transmission component whenever the contextual state changes, the proposed method provides the provenance monitoring middleware with a time-stamped, evolving set of contextual states. FIG. 1 shows an enhanced data consumer (e.g., a Web mashup application) 109 using the data 122 from the data repository 106 and corresponding metadata 123 from the provenance metadata repository.

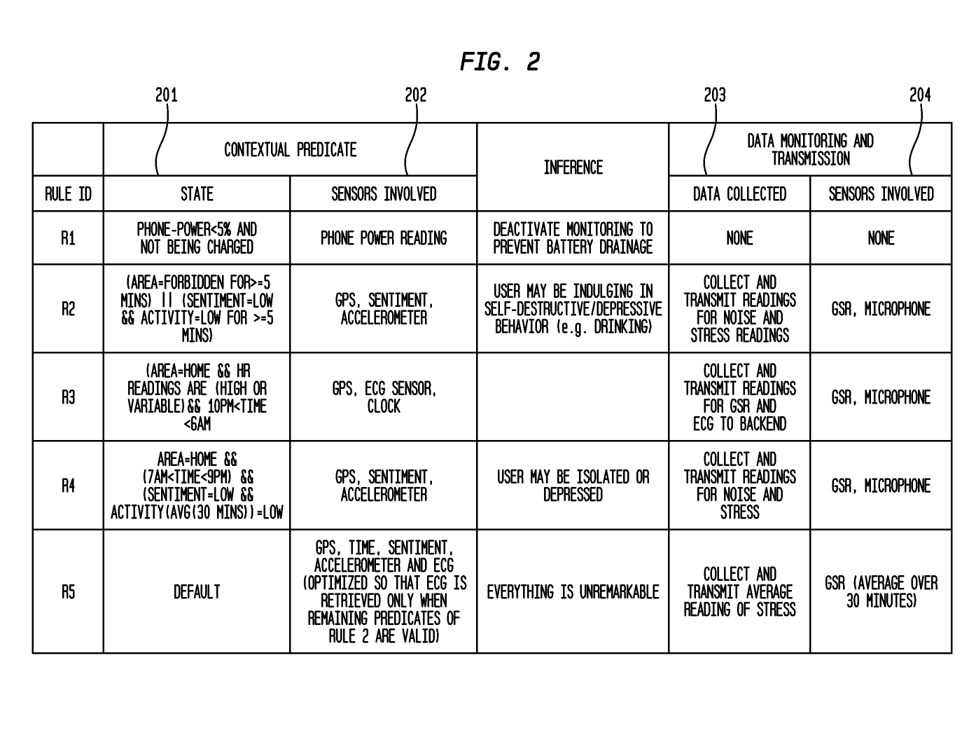

An exemplary embodiment of the adaptation logic employed by the monitoring application 102, and its dependence on the user's contextual state is illustrated in the table in FIG. 2. The remote monitoring application is modeled as a set of <predicate, collection action> rules. The predicates themselves refer to a set of contextual conditions, which, as is known in the state-of-the-art, may be defined as a hierarchy of context composition, with the lowest level of the hierarchy typically referring to some ‘raw’ information (e.g., sensor data), and intermediate levels refer to various logical operations (e.g., temporal averaging, logical conjunction or spatial correlation) of the underlying data. FIG. 2 shows five different contextual conditions (R1-R5) and the corresponding sets of data sources that are collected and transferred by the remote monitoring application. Column 2 201 describes the contextual condition (in this example a set of conjunctions and disjunctions) that is defined through appropriate operations over the set of sensors 202 defined in column 3. When any one of these contextual conditions (i.e., a row in the table) is valid, the Data Monitoring and Transmission component is adapted to perform the collection action described in column 5 203, involving the transmission of the sensors specified 204 in column 6.

One aspect of the invention is to enable the backend server and context repository to not only provide the ‘top-level’ context associated with a data ‘collection action’ at a point in the past, but to also enable the data consumer to see other ‘intermediate’ states in the context operator graph.

The low overhead contextual provenance capture mechanism relies on the application-specific definition of causative context. As an example, a Context Composition Graph (CCG) is a preferred way to capture this application-specific information. A CCG is a construct that represents the hierarchical process by which highlevel contextual inferences are made by composing low-level sensor-generated data samples. Formally, a CCG is defined as a graph <V;E; F> (V being a set of nodes, connected by a set of edges E and associated with a set of dependency functions F), where a node vi 2 V corresponds to either a specific contextual state or a simple ‘logic operator’ (either AND, OR or NOT) that expresses how higher level contextual states may be obtained from the values of underlying contextual state nodes. The nodes are connected by directed edges eij 2 E, such that an edge from a contextual state vi to a contextual state vj implies that vi is a higher level context state, whose computation involves the composition of context represented by vj. In this case, vi=PARENT(vj) and vj=CHILD(vi). Similarly, edges from state nodes to logic operator nodes imply that the state is computed by applying the corresponding operator to the ‘child’ states, while edges emanating from logic operator nodes point to the sources of underlying context to which the operator is applied. Furthermore, each edge is associated with a causative function fij, that specifies a causative relationship between an value of the contextual node vi at time t and the present or past values of the contextual node vj.

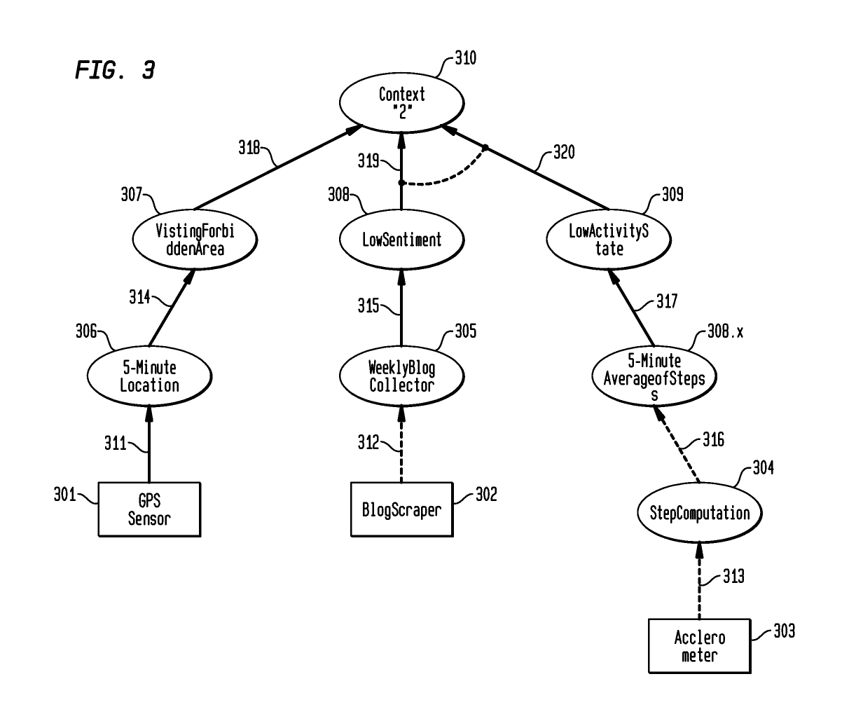

In a preferred embodiment of the invention, the contextual predicates may be viewed as a context composition or operator graph over external data streams or sources, with both the sink operator and intermediate operators defining various contextual states. FIG. 3 shows a tree-like graph of the hierarchical context composition for Rule #2 in FIG. 2. The graph consists of the highest-level context, namely “(Area=forbidden for >=5 mins)∥(sentiment=low && activity=low for >=5 mins)” being at the root 310 of the tree and the lowest level sensor data inputs (comprising the GPS sensor 301, the BlogScraper sensor 302 that mines Internet-accessible blog entries and applies user sentiment analysis on the text, and the accelerometer 303 provided tri-axial acceleration data) forming the leaves of the tree. Intermediate nodes represent intermediate, derived, contextual states—e.g., the “5 minute location” state 306 utilizing data 311 from the GPS sensor represents the ‘principle location of the user over a five minute window’, the “weekly blog collector” 305 state represents a week's worth of blog entries created by the user and is derived 312 from the BlogScraper inputs, the “StepComputation” 304 state reflects the number of steps taken by the user as deduced by operating 313 over Accelerometer readings. This process of context composition occurs in recursive fashion—e.g., the “Visiting Forbidden Area” state 307 uses the evolutionary history 314 of the “5 minute location” state, the “LowSentiment” state 308 is derived by analyzing the words and phrases gathered by the “weekly blog collector” state 315, the “5 minute AverageofSteps” state 309 is derived 316 from the StepComputation state, the “LowActivityState” is derived 317 in turn from the “5 minute AverageofSteps” state and the highest level context “Rule 2” is derived from a logical conjunction and disjunction 318, 319, 320 of the intermediate-level states 307, 308 and 309 respectively. In a preferred embodiment of the invention, this state-level graph (a function of the underlying logic of the monitoring application) is communicated and stored in the provenance metadata repository 107 as a static data structure. During the actual operation of the application, each of the intermediate contextual states can then be monitored, so that the Provenance Monitoring and Transmission component 105 receives updates about the temporal evolution of the intermediate states. Once state information is transmitted and stored in the backend (with appropriate timestamps), there is the ability to reconstruct the contextual states of the user at any previous time instant to an appropriate depth, by effectively utilizing the static state-level tree and the dynamic history of state evolution. As one possibility, the static state-level graph may be specified at different depth on different paths—in the example shown in FIG. 3, the bold line arcs (318. 319, 320, 314, 315, 311, 317) represents connections between nodes that are specified in the graph. Only nodes that are children of such ‘bold’ connectors will have their state values monitored by the Provenance Monitoring and Transmission component 105 and thus stored in the backend provenance metadata repository 107. To optimize the transmission of context, a ‘delta transmission’ mechanism is employed, whereby a contextual state (either top-level or intermediary) is transmitted only when the most recent value differs from the previously transmitted value. When a consumer of this metadata queries the provenance, backtracing on these arcs may be used to iteratively reveal the contextual state of the user at different depths. Techniques for backtracing over such hierarchical state or operator graphs may include approaches embodied in U.S. Pat. No. 7,539,753, “Methods and Apparatus for Functional Model-Based Data Provenance in Stream Processing Environments” and in N. Vijayakumar and B. Plale, “Towards Low Overhead Provenance Tracking in Near Real-Time Stream Filtering” IPAW 2006, both of which are incorporated herein by reference. The method of storing a static version of the operator graph, coupled with the delta transmission of contextual state values, enables provenance collection in a mobile device-centric environment with very low communication overhead.

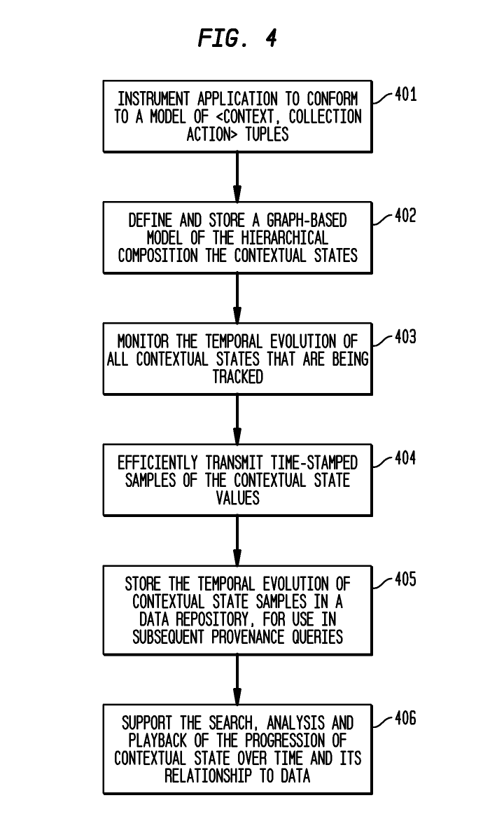

FIG. 4 is a flowchart of logical steps for practicing the present invention. In the first step 401, the adaptive remote monitoring application logic is modeled as a set of <context, collection action> rule tuples. Note that this can be done in a variety of ways—e.g., explicit coding by the application programmer, the specification of each tuple in a specified syntax (e.g., XML) or the automated inferencing of this logic by inspection of source code or application runtime behavior. In the second step 402, each of the context predicates defined in the rule tuples is associated with a context-state graph that represents the process of hierarchical context composition; this graph is then stored in the provenance metadata repository 107. In the next step 403, the remote monitoring application is instrumented to provide the provenance monitoring subsystem samples of the temporal evolution of such contextual states. The provenance monitoring subsystem on the mobile device can then use appropriate techniques (e.g., delta-based transmissions, compression, etc.) to efficiently transmit 404 this metadata to the backend repository for storage 405. In a subsequent step 406 the system provides a graphical user interface to support browsing, query entry and response, and condensed summarized “playbacks” of provenance information and its relationship to raw data. In this way, provenance metadata can be understood and acted upon by practitioners or users without requiring those practitioners or users to be experts in data analysis or visualization. In a preferred embodiment such a step would involve a user making use of a 3-tier model in which a Web-based interface was exposed to the user for presentation, a business layer on a server 107 implemented business and transformation logic, and a data layer stores the data and metadata in question one in more local or distributed databases. The “playback” mode would be a feature of the Web interface and would mesh together a timeline, VCR-like functions to change time period and scale, overlapping data graphs using user-configurable layers of data, ability to expand and zoom into and out of contextual or provenance detail, and friendly graphics to clearly indicate regions of interest on the graph(s).

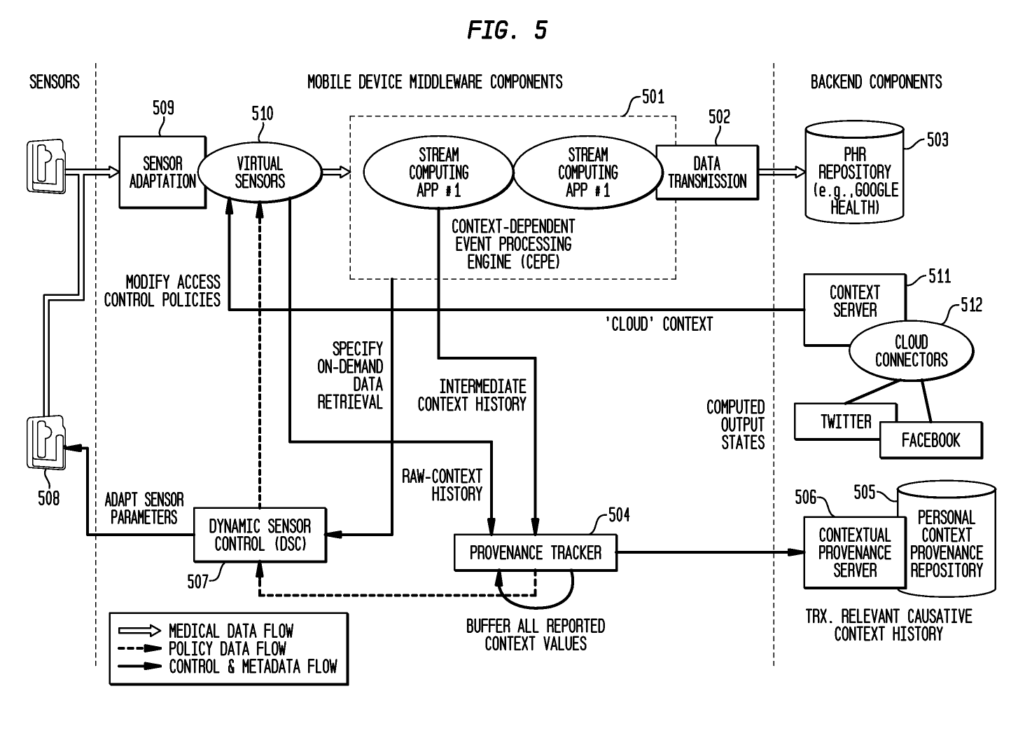

The component-level functional architecture of the system is shown in FIG. 5. The architecture supports context dependent event monitoring, with contextual triggers dynamically altering the set of monitored sensors and the local stream analytics. At the heart of the client-side infrastructure is a Context-Dependent Event Processing Engine (CEPE) 501, responsible for the processing logic applied to the incoming data streams. Note that in a preferred embodiment these streams are modeled as a sequence of time-value tuples. A Data Transmission sub-component 502 pushes relevant data streams to the PHR repository 503. The CEPE supports both push and pull based data streams and can perform optimizations based on the operational cost of a particular sensor (for example, sensors that are most likely to falsify a conjunctive predicate in the contextual rule are allowed to push data; Data from the other sensors are selectively pulled only when that predicate evaluates to true).

Provenance Tracker (PT) 504 is notified about the temporal evolution of contextual states. The PT collects these notifications and subsequently uploads the contextual provenance to the Personal Context Provenance (PCP) 505 repository. The PCP is managed by the Contextual Provenance Server (CPS) 506 at the server end.

The Dynamic Sensor Control (DSC) 507 component implements the ‘on-demand’ data collection logic. It is responsible for duty-cycling individual sensors 508 and for adjusting appropriate collection and transmission parameters like sampling rates, transmission power, schedules etc.

The Sensor Adaptation(SA) 509 component consists of a collection of device/schema-specific adapters, that transform the device-specific data formats from an individual sensor into a uniform event-tuple representation. To accommodate complex sensor data types and allow quick retrieval of canonical data properties, a combination of object-oriented (name, value) and XML-based event representation schema are used. The Virtual Sensor (VS) 510 component serves to shield the CEPE from device specific features of individual sensors by providing an uniform abstraction across local sensors on the phone, external physiological sensors and context sensors in the Internet cloud 512. It also allows independent monitoring applications to utilize a common set of software objects.

The VS also enforces additional access control policies to arbitrate between multiple applications. In addition, the VS also serves as a means for applications to leverage upon previously existing context composition logic.

The Context Server (CS) 511 is responsible for implementing the context sensor connectors. For example the CS can periodically retrieve textual content from the subject's Twitter™ posts, run a sentiment analysis algorithm on the text and return a score to the appropriate client-side VS.

Each application is structured as a set of <ContextualTrigger, Action> triples. Whenever the predicate specified by ContextualTrigger is satisfied, the data collection and processing logic in the corresponding Action element is invoked. This process of context composition is modeled as a stream operator graph, with individual nodes representing different contextual states. (Different nodes in this context composition graph can also be encapsulated as Virtual Sensors, enabling other monitoring applications to directly utilize the corresponding inferred context in their context composition process.) Once the operator graph is specified, the application programmer is responsible for implementing it within the CEPE, as well as making sure that appropriate changes in the contextual state are reported to the Provenance Tracker. The Action element of each tuple is also implemented as an operator graph over a set of streams from underlying Virtual Sensors. The output of the Action element is a set of “event streams”.

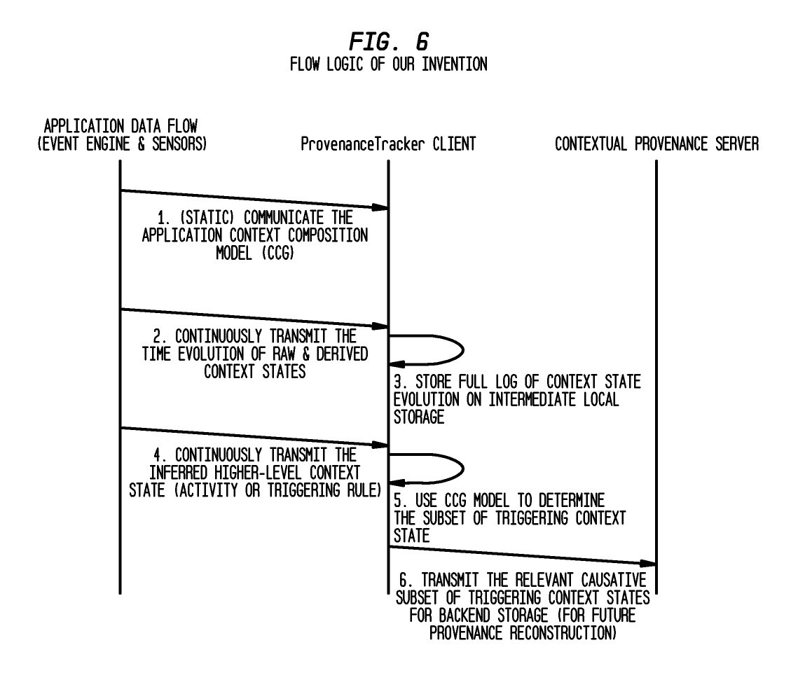

FIG. 6 shows the flow logic of the present invention. Application Data Flow (ADF) communicates the application context composition model (CCG) to the Provenance Tracker Client (PTC). The ADF also continuously transmits the time evolution of raw and derived context states to the PTC. The PTC stores full log of the context state evolution on intermediate local storage. The ADF continuously transmits the inferred higher-level context state (activity or trigger rule) to the PTC. The PTC uses the CCG model to determine the subset of triggering context state. Finally, the PTC transmits the relevant causative subset of triggering context states for backend storage (for future provenance reconstruction).

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc. A module may be a component of a device, software, program, or system that implements some “functionality”, which can be embodied as software, hardware, firmware, electronic circuitry, or etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server, and/or embedded system.

While there has been described and illustrated a method and system for specifying, capturing, collecting, storing, transferring and replaying over metadata causative contextual history that elaborates on data collected by an adaptive remote monitoring application using a mobile device, it will be apparent to those skilled in the art that modifications and variations are possible without deviating from the principles and broad teachings of the present invention which shall be limited solely by the scope of the claims appended hereto.

What is claimed is:

1. A method of capturing, transmitting and reconstructing causative contextual history that elaborates on data collected by an adaptive continuous remote monitoring application using one or more mobile devices as a gateway, the method comprising the steps of:
expressing the adaptation logic of a remote continuous monitoring application via a set of <contextual predicate, data collection action> tuples;
monitoring the temporal evolution of the states that define the matching contextual predicates at any instant;
transferring the temporal evolution of causative contextual history to a backend repository for storage independently of the raw readings and data gathered by the application; and
supporting queries on and reconstruction of the stored causative contextual history to recover the applicable context associated with some past time interval or set of raw readings.

2. The method as set forth in claim 1, where in the causative contextual history is determined from on-board sensors, locally connected sensors, and remote data sensors and is stored and transmitted separately from the raw readings.

3. The method as set forth in claim 1, wherein contextual predicates comprise obtaining personalized context stored in—or derived from—an information source in the network cloud and attaching sensor actions to context evaluation.

4. A method for storing, tracking and recreating the relevant causative contextual history of a user with regard to raw data sensed at the user, the method comprising the steps of:
modeling the process of context composition as a graph, with nodes representing intermediate and final context states;
storing a representation of the graph;
tracking and storing the temporal evolution of various context states; and
back-tracing over the stored graph representation and the temporal evolution data to recreate the contextual history at a previous time instant.

5. A system for capturing causative contextual history for remote monitoring comprising:
an adaptive remote monitoring application residing on a mobile device;
monitored data repository for storing a first output from the adaptive remote monitoring application;
provenance monitoring and transmission component which monitors changes in a second output from the adaptive remote monitoring application for providing a separate history of context evolution to a provenance metadata repository; and
fusing and outputting data from the monitored data repository and from the provenance metadata repository for use by an end user.

6. The system as set forth in claim 5, wherein said adaptive remote monitoring application comprises context computation and data monitoring and transmission.

7. The system as set forth in claim 6, further comprising on-board sensors, locally collected sensors and remote data source for providing data to said context computation.

8. The system as set forth in claim 6, wherein said data monitoring and transmission receives data from on-board sensors and locally collected sensors and provides an output to said monitored data repository.

9. The system as set forth in claim 6, wherein said data monitoring includes the interpretation and fusion of multiple context sources on an Internet.

10. The system as set forth in claim 6, further comprising a provenance monitoring and transmission for receiving an output from said context computation and providing causative contextual history to said provenance metadata repository.

11. The system as set forth in claim 5, wherein contextual predicates are viewed as an operator graph over external data.

12. The system as set for in claim 10, wherein contextual states are reconstructed for a previous time period at an appropriate depth.

13. A method of capturing, transmitting and reconstructing causative contextual history that elaborates on data collected by an adaptive remote monitoring application using a mobile device, the method comprising the steps of:
modeling adaptive remote monitoring application as a set of <context, collection action> rule tuples;
associating each context predicate with a context-state graph representing the process of hierarchical context composition and storing the graph;
provenance monitoring subsystem samples of the temporal evolution of all contextual states that are being tracked;
transmitting time-stamped samples of the contextual state values to a data repository separately from sensed data; and
storing the temporal evolution of contextual state samples in the data repository for playback of provenance information and its relationship to raw data.
